(19) United States
(12) Patent Application Publication
(10) Pub. No.: US 2010/0154153 A1
(43) Pub. Date: Jun. 24, 2010

(54) PIPELINE PIG BRUSH

(75) Inventors: MICHAEL HOOPER, Chestermere (CA); WENG CHEE FOONG, Calgary (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(73) Assignee: 766089 ALBERTA LTD., Calgary (CA)

(21) Appl. No.: 12/646,507

(22) Filed: Dec. 23, 2009

Related U.S. Application Data
(60) Provisional application No. 61/140,784, filed on Dec. 24, 2008.

(51) Int. Cl. F16L 55/28; A46B 3/10; B23P 11/00

(52) U.S. Cl. 15/104.05; 15/179; 29/525.02

(57) ABSTRACT

A pipeline pig, brush and method of assembly of the pipeline pig brush is provided. The pipeline pig brush has a first plate and a second plate. The first plate has a plurality of recesses provided in a rear face. The second plate has a plurality of recesses provided in a front face that can be substantially aligned with the plurality of recesses in the back face of the first plate. A number of brushes, each brush having a ferrule and a tuft of bristles, can be clamped between the first plate and the second plate where they are held in place between the first plate and the second plate by the recesses with their tuft of bristles extended beyond the sides of the first plate and second plate.

### FIELD

The present invention relates to the field of pipeline pigs, which are devices for passing through pipelines to clean and/or inspect them.

### BACKGROUND

Most pipelines that carry fluids need to be “pigged” at certain times. This is accomplished by inserting a pig into the pipeline at a first point and allowing a driver, such as the force of fluids flowing through the pipeline, to move the pig through the pipeline to a second point where it is caught and removed from the pipeline.

Normally, pipeline pigs fall into two basic categories, non-intelligent pigs and intelligent pigs. Non intelligent pigs are those that perform a maintenance or operational function, e.g. cleaning,—such as scraping of solids from the interior of the pipe; swabbing—such as removing liquids or gases from the pipeline; batching—such as separating different fluids in the pipeline, etc. Intelligent pigs are those that monitor and convey information about a particular condition or performance of the pipeline.

Such pigs include extensions of body material to ride against the interior surface of the pipe through which they are conveyed. Body extensions may include foam, rubber seals, bristles of a brush-like structure, etc. Such extensions may act to contact the pipeline inner wall to measure a wall parameter, provide electrical or magnetic contact between the pig and the wall, centralize the pig in the pipeline or scrape against the walls.

### SUMMARY

The present invention provides a new pipeline pig.

In accordance with one aspect of the present invention, there is a pipeline pig brush provided comprising: a first plate having a front face, a rear face and side edges; a second plate having a front face, a rear face and side edges, the second plate positioned in series with the first plate such that the rear face of the first plate faces the front face of the second plate; at least one first plate recess on the rear face of the first plate; at least one second plate recess on the front face of the second plate, the at least one second plate recess substantially aligned with the at least one first plate recess on the first plate; and at least one brush having a ferrule and a tuft of bristles, the at least one brush clamped between the first plate and the second plate and positioned to correspond with the at least one first plate recess and the at least one second plate recess and with the tuft of bristles extending past the side edges of the first plate and the side edges of the second plate.

In accordance with one aspect of the present invention, a pipeline pig is provided comprising: a mandrel; and a pig brush retained on the mandrel. The pig brush comprises:

a first plate having a front face, a rear face and side edges; a second plate having a front face, a rear face and side edges, the second plate positioned in series with the first plate, such that the rear face of the first plate faces the front face of the second; at least one first plate recess on the rear face of the first plate; at least one second plate recess on the front face of the second plate, the at least one second plate recess substantially aligned with the at least one first plate recess on the first plate; and at least one brush having a ferrule and a tuft of bristles, the at least one brush clamped between the first plate and the second plate and positioned to correspond with the at least one first plate recess and the at least one second plate recess and with the tuft of bristles extending past the side edges of the first plate and the side edges of the second plate.

In accordance with one aspect of the present invention, a method of assembling a pipeline pig brush is provided. The method comprises: providing a first plate and a second plate, the first plate have a plurality of recesses in a back face of the first plate and the second plate having a plurality of recesses in a front face of the second plate; placing brushes, each brush having a ferrule and a tuft of bristles, in the recesses in the back face of the first plate so that the tuft of bristles on each brush extends outwards past the side edges of the first plate; aligning the plurality of recesses on the front face of the second plate with the plurality of recesses on the front face of the second plate; and securing the first plate together in series with the second plate to clamp the brushes between the first plate and the second plate wherein the brushes are held in place between the first plate and second plate by the plurality of recesses.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

FIG. 1 is an isometric view of a pipeline pig brush according to the present invention.

FIG. 2 is a side view of the pipeline pig brush of FIG. 1.

FIG. 3 is a top plan view of the pipeline pig brush of FIG. 1.

FIG. 4 is schematic drawing of a pipeline pig.

FIG. 5 is a side view of another pipeline pig brush.

FIG. 6 is an isometric view, partially cut away, of a pencil brush useful in a pipeline pig brush.

### DETAILED DESCRIPTION OF VARIOUS EMBODIMENTS

The description that follows, and the embodiments described therein, is provided by way of illustration of an example, or examples, of particular embodiments of the principles of various aspects of the present invention. These examples are provided for the purposes of explanation, and not of limitation, of those principles and of the invention in its various aspects. In the description, similar parts are marked throughout the specification and the drawings with the same respective reference numerals. The drawings are not necessarily to scale and in some instances proportions may have been exaggerated in order more clearly to depict certain features.

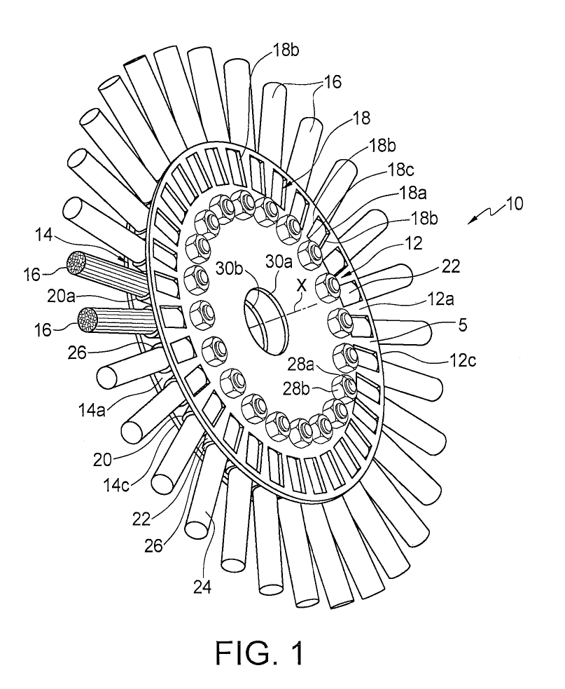

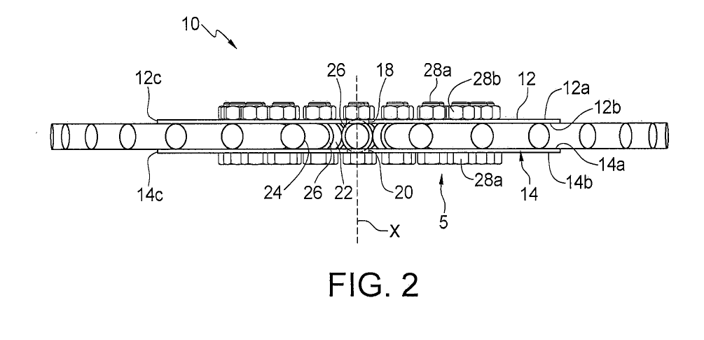

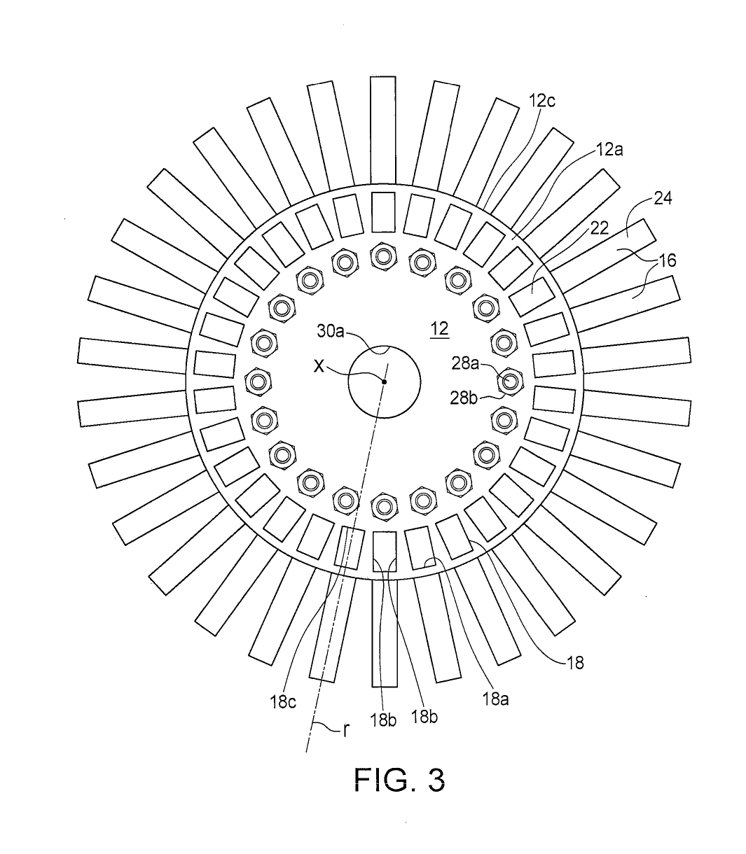

Reference will now be made to the Figures, which show various embodiments of the brush. A pipeline pig brush 10 according to one embodiment of the invention is shown in FIGS. 1 to 3. Such a brush 10 may include a retainer 5 including a first plate 12 and a second plate 14 and a plurality brushes 16 held by the retainer 5.

First plate 12 includes a front face 12a, a rear face 12b and side edges 12c. Second plate 14 also includes a front face 14a, a rear face 14b and side edges 14c. The retainer 5 includes the first and second plates 12, 14 arranged and secured together in series with rear face 12b of the first plate facing front face 14a of the second plate. The plates 12, 14 may be shaped in various ways. Their edge shapes may be the same or different and may be circular, rounded or polygonal (i.e. triangular, octagonal, irregular, etc.). Since pipelines often have cylindrical inner diameters, the use of a pair of similarly sized circular plates may facilitate construction.

In the retainer 5, the plates 12, 14 are substantially aligned such that their center points are substantially aligned and positioned along a long axis x of the brush retainer 5. If the plates 12, 14 are shaped similarly, the side edges of the plates 12, 14 may also be substantially aligned.

First plate 12 further includes a recess 18 on its rear face 12b and second plate 14 further includes a recess 20 on its front face 14a. The first plate recess 18 and the second plate recess 20 each are spaced from the side edges of their plates 12, 14 such that a shoulder 18a, 20a is formed where the surface of the plate material drops from the face into the recess 18, 20. Shoulders 18a, 20a each face away from the side edges 12c, 14c. When the plates 12, 14 are connected in the retainer 5, first plate recess 18 on the first plate 12 is held with its shoulder 18a in substantial alignment, along an axis parallel to axis x, with shoulder 20a of the second plate recess 20 in the second plate 14.

As noted above, the pipeline brush 10 further includes a plurality of brushes 16. Each brush 16 of the plurality of brushes 16 includes a ferrule 22 and a tuft of bristles 24 retained by the ferrule 22. A stepped portion 26 is formed between the ferrule 22 and the tuft of bristles 24, where the tuft of bristles 24 extends out from the ferrule 22.

In the pipeline brush 5, the plurality of brushes 16 are clamped between first plate 12 and second plate 14 with stepped portion 26 of each of the plurality of brushes 16 engaged behind the shoulders 18a, 20a of the first plate recess 18 of the first plate 12 and the second plate recess 20 of the second plate 14. When the plurality of brushes 16 are clamped between the plates 12, 14 of the retainer 5, tufts 24 of the plurality of brushes 16 extend out beyond the side edges 12c, 14c of the first plate 12 and the second plate 14.

The plates 12, 14 may be spaced apart to provide a gap through which the tufts 24 extend, as shown. Alternately, the plates 12, 14 may include channels formed between the recesses 18, 20 and the side edges 12c, 14c though which the tufts 24 pass.

Brushes 16 may be held simply by clamping and mechanical engagement between and behind the shoulders 18a, 20a of the plates 12, 14. The plates 12, 14 may be formed and secured together in various ways to hold brushes 16. The plates 12, 14 may be formed of durable materials such that they can withstand pipeline conditions and hold the brushes 16 firmly. For example, the materials of the plates 12, 14 may be selected to withstand and act against any material failure caused by the various pulling and twisting forces that will be present. The plates 12, 14 may be secured together in various ways including by welding, clamping, fastening. In the illustrated embodiment, the plates 12, 14 each include a plurality of fastener holes through which fasteners such as bolts/nuts 28a, 28b can be secured. The bolts 28a can be extended through aligned apertures and tightened to clamp the plates 12, 14 together about the brushes 16. The apertures for the bolts 28a may be positioned adjacent the base of the recesses 18, 20 and these apertures can be positionally selected with consideration to the position of the recesses 18, 20 such that the plates 12, 14 are retained in a selected relative position such that the facing recesses 18, 20 become substantially aligned.

By use of fasteners such as bolts 28a, the plates 12, 14 may be easily secured together and disconnected and any space between them to accommodate the brushes 16.

Each plate 12, 14 may include one or more recesses 18, 20 to accommodate brushes 16. Recesses 18, 20 may each take various forms. In one embodiment, recess 18 and/or 20 may define an elongate slot running along a length or fully around the plate 12, 14 on which it is located along its edge and into each of which a plurality of brushes 16 may be placed. Alternately, each recess 18, 20 may be formed to accommodate only one brush 16, as shown. For example, in the illustrated embodiment, plate 12 includes a plurality of recesses 18, each of which are small, rectangularly shaped and spaced apart and sized to only accommodate one brush 16. The plurality of recesses 18 in the illustrated embodiment, are each spaced similarly away from side edge 12c. Of course, each recess 18, 20 could be formed in a more elongate form by joining a number or all of the recesses 18, 20 on the plate 12, 14, such that each recess 18, 20 may accommodate a longer brush 16 or a plurality of brushes 16.

The recesses 18 may be formed to form side shoulders 18b in addition to shoulder 18a at the edge end of the recess 18. Side shoulders 18b may be formed with consideration to the shape of ferrule 22 to hold any brush 16 placed therein against lateral movement and twisting between shoulder 18a and the stepped portion 26 of the ferrule 22. In the illustrated embodiment, recesses 18 also include lower shoulders 18c that support the lower end of the ferrule 22 to act against the brush 16 being driven down between the plates 12, 14. As such, a recess 18 including shoulders 18a, 18b and 18c may act to firmly hold any brush 16 positioned therein substantially against moving out of position. By clamping the plates 12, 14 tightly or forming the ferrule 22 with shoulders 18a, 18b, 18c , the brushes 16 may also be held against twisting about their long axis.

The depth of the recesses 18, 20 can be selected to create a shoulder 18a simply to retain the stepped portion 26 of the brush 16 therein. Alternately, as shown, the recesses 18, 20 can have a depth creating a shoulder 18a, 20a to fully accommodate the depth of stepped portion 26 between the outer surface of ferrule 22 and the outer surface of the tuft 24. In such an embodiment, the material of the plate 12, 14 may actually bear against tuft 24 when the plates 12, 14 are clamped about the brushes 16.

Because the recesses 18, 20 act to retain the brushes 16 between the plates 12, 14, the recesses 18, 20 can be formed to hold the brushes 16 firmly therebetween in various orientations. For example, recesses 18 of the illustrated embodiment are formed with their shoulders 18a extending orthogonally from a radial line r relative to center axis x such that the brushes 16 are shown extending out radially from the plates. However, recesses 18 can be formed to hold the brushes offset from radially extending position, if desired.

Although recesses 18 and 20 are shown extending fully through the material of the plate 12, 14 on which they are positioned (i.e. to open on each of the front and the rear surfaces of the plate 12, 14), it is to be understood that such recesses 18, 20 may simply be indentations on the face of the plate 12, 14 that do not pass fully through the thickness of the plate 12, 14.

One or both plates 12, 14 may, as shown, include a substantially central mounting aperture 30a, 30b for permitting the mounting of the pipeline pig brush 10 on a tool mandrel. Any central mounting aperture may, if desired, be oriented to allow mounting of the plates with their recess shoulders 18a, 20a substantially aligned.

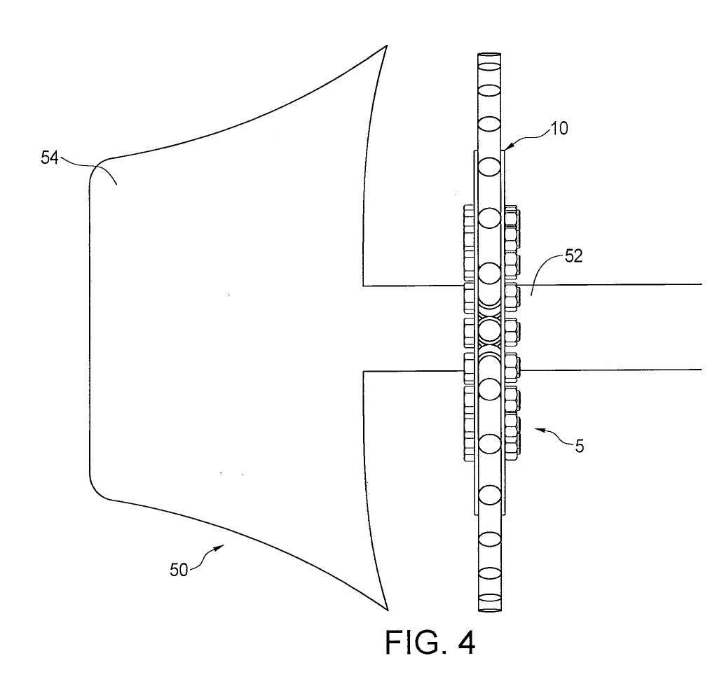

A tool mandrel may be an assembly device useful for arranging and aligning the plates 12, 14 during assembly. Alternately, with reference to FIG. 4, the tool mandrel may be a portion of pipeline pig 50 that retains the pipeline pig brush 10. For example, the tool mandrel may be a mandrel 52 that retains the brush 10, as by fasteners, welding, clamping, etc. and also includes a driver 54 for the pig 50. The driver 54 may include an active device such as a crawler or an inactive pressure driven device such as a seal cup (as shown), a foam plug, further brushes, etc.

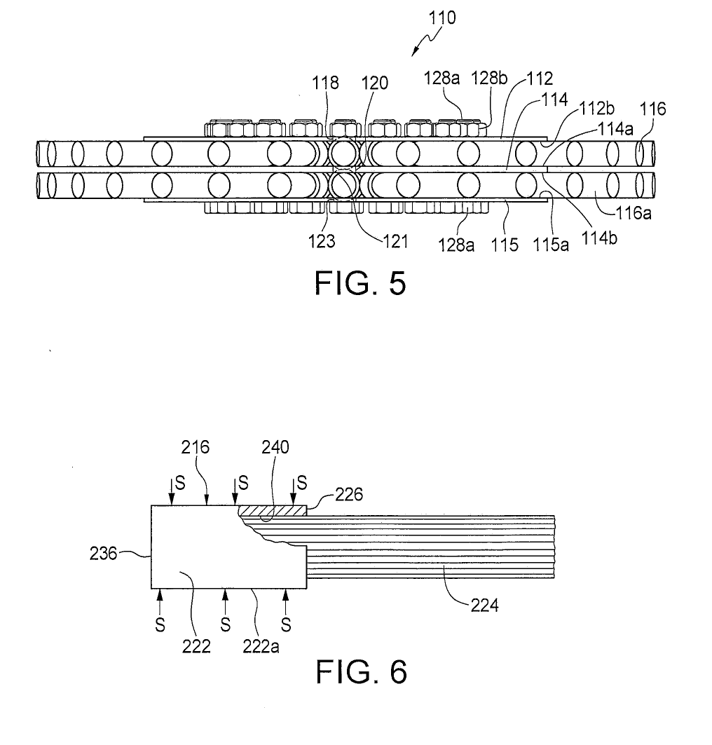

In one embodiment, a brush may be formed with more than two plates. An example of such a pipeline pig brush 110 is shown in FIG. 5, which includes three plates 112, 114, 115. Plates 112, 114 have recesses 118, 120, shown in phantom, formed on their facing sides 112b, 114a, in which a plurality of brushes 116 are retained. Plates 114, 115 also have recesses 121, 123 (shown in phantom) formed on the rear face 114b of the second plate 114 and on front face 115a of the third plate 115 in which a plurality of brushes 116a are retained. While recesses 121, 123 are shown aligned with recesses 118, 120, in FIG. 5, it is to be noted that recesses 121, 123 for the brushes 116a can be offset from the recesses 118, 120 for brushes 116. Such offset positioning allows the brushes 116 between the first two plates 112, 114 to be offset from those clamped between plates in subsequent series, i.e. those secured between the second and the third plates 114, 115, to provide greater coverage of the bristles along a full circumference of the pipeline pig brush 110. Plates 112, 114, 115 may all have alignable apertures for accepting fasteners 128a/128b and central apertures (cannot be seen in this view) for accepting therethrough a tool mandrel. While plate 114 is shown as a single unit with recesses on each of its front and rear surfaces 114a, 114b, it is to be understood that similarly appearing brushes may be constructed using multiple plates installed directly side by side.

To assemble a pipeline pig, the tuft brushes may first be installed in the retainer and the retainer then installed on the pipeline pig mandrel. For example, ferrules of brushes 116 may be placed in the recesses 118, 120 of one of the plates 112, 114 between which they are to be clamped and the opposite plate 114 or 112 may be positioned with its recesses 120 or 118 overlying the ferrules of the tuft brush 116. The plates 112, 114 may then be secured together to clamp brushes 116 therebetween and to create an assembly pipeline pig brush 110. Further tuft brushes 116a and plates 115 may be added as desired. Thereafter, the brush 110 may be installed on a central mandrel of a pipeline pig.

The brushes 16 may be formed in various ways using a tuft 24 of bristles and a ferrule 22 such that stepped portion 26 is formed to be engaged behind recess shoulders 18a, 20a. Of course, any brush 16 may be sufficiently durable, with consideration as to pipeline conditions, such that it can withstand at least one pass through a pipeline substantially without breaking down, losing bristles, completely wearing away, or generally failing.

In some useful embodiments, the brush is formed by providing a ferrule, inserting a plurality of bristles therein and securing the bristles in the ferrule by welding, soldering, gluing and/or swaging. One example brush 216 is shown in FIG. 6, which includes a ferrule 222 and a tuft of bristles 224 secured therein. The thickness of the wall of the ferrule 222 creates stepped region 226.

Various options for brushes 216 and processes for producing them are described in applicant's earlier applications US 2007/0151055, published Jul. 5, 2007 and US 20050283930, published Dec. 29, 2005. These documents are incorporated herein by reference. While the processes are fully described in the published US applications, a brief discussion of various options follows.

In the tuft, the bristles 224 may be metal filaments, fibers, wires or other such elongate structure. Any of a number of different types of metals may be used, depending upon the application. For example, in one embodiment the metal may be steel, for example carbon steel. In another embodiment, the bristles may be coated wires. In brushes used for MFL tools, magnetically transmissive metals may be used. In brushes used for cleaning tools, transmissivity or conductivity of the bristle may not be as important as the strength or durability of the bristle. The bristles may also be non-metal, for example, plastic monofilaments, natural type fibers and synthetic fibers such as nylon fibers impregnated with silicon carbide. The latter may be used in a pipeline pig for cleaning. A tuft may be made of more than one type of bristle.

The cross-sectional shape and size of the bristles useful in a brush 216 may be selected to maximize the contact of the bristles with one another, and to minimize the air space between the bristles. A number of different cross-sectional shapes and sizes of bristles may achieve this result. As non-limiting examples, the bristles may be circular, rounded, polygonal (non-limiting examples are triangular, tetragonal, hexagonal) or irregular in cross section. The bristles may be packed tightly within the ferrule, resulting in no, or negligible, air space between the bristles. As is apparent, all bristles in a tuft need not have the same or similar cross-sectional shape or size in order to achieve a closely spaced relation within the ferrule.

Ferrule 222 may be formed of metal or polymeric material as a metal tube, sleeve, cup, bushing, etc. that comprises at least one retention cavity 240, such as an opening or bore, for insertion of tuft of bristles 224 therein. Retention cavity 240 may be accessible from both ends, or it may be closed or partially closed at one end. The material thickness between the retention cavity 240 and outer surface 222a of the ferrule 222 creates a wall thickness. The ferrule may be polygonal, circular or rounded in cross section. A circular form as shown may be most easy to source and manufacture.

To assist in the positioning of the bristles 224 into the ferrule 222, the opening about retention cavity 240 may be beveled.

The retention cavity 240 may have sides that are parallel to one another, as in a cylinder. Alternatively, retention cavity 240 may have sides or a portion thereof that are not parallel to one another, but rather are curved, flared, cone-shaped or irregular in shape.

The bristles 224 of the tuft may be packed in a closely spaced relation within ferrule 222, meaning that the bristles 224 may be packed so as to minimize the amount of air space between the bristles 224 and to maximize the amount of contact of the bristles 224 to each other and to inner surface of retention cavity 240. Packing of the bristles 224 in a closely spaced relation within the ferrule 222 may be important for brushes 216 used in MFL tools, as decreasing the air space increases the transmissivity. Close packing may also be important for maximizing the durability and lifespan of the brush 216. If the bristles 224 are packed in a closely spaced relation, they may be less likely to become detached from the ferrule 222 during use of the brush 216.

The bristles 224 may be secured to each other and to the ferrule 222 by using soldering, welding, glue, swaging, or a combination thereof.

In one embodiment, the bristles 224 are glued to each other and to the ferrule 222. As the environment of the bristles 224 in the ferrule 222 lacks significant air or oxygen, anaerobic glues may be most useful in securing the bristles 224, as these glues are able to cure in the absence of air or oxygen. However, it is possible that other glues of sufficient strength, even if not anaerobic, may be used. The glue viscosity, as viscosity will affect the capillary action of the glue and therefore its ability to wick up into and between the bristles, and thereby to coat the bristles in the bundle. Examples of useful anaerobic glues, are anaerobic glues from Loctite®, such as Loctite 603 Retaining Compound. One useful glue has a viscosity @ 25° C., mPa·s (cP), Brookfield RVT, Spindle #1, 20 rpm, of 100 to 150^{LMS}, however glues with other viscosities may be used as well. When gluing, the bristles 224 may be cleaned to remove oil and debris, before applying the glue and gluing the bristles 224 into the ferrule 222. This can be accomplished by soaking the bristles 224 in a cleaner such as acetone and/or degreasers, by standing the bristle 224 bundle vertically in a bath of cleaning solution.

A primer may also be applied to the bristles 224, before the glue is added. The primer may be used when gluing inactive metals, for example, plated metal, titanium, stainless steel, galvanized steel, zinc, pure aluminum, gold, silver, cadmium, magnesium, or active metals such as iron, plain steel, copper, brass, bronze and nickel. The primer strengthens the bonding of the glue to both active and inactive metals, for example by creating a rough etched surface, which allows the glue to form a stronger bond with the surface.

In addition to using glue, or instead of using glue, the tuft of bristles 224 may be held in the ferrule 222 by the use of swaging. Swaging is a process that is used to reduce the diameter of tubes and/or rods by applying compressive force to secure parts together. Hammering may be used to apply an inwardly directed force to ferrule 222. Alternately, swaging presses, such as hand, bench and hydraulic presses may be used. Generally, a swaging press comprises an annular ring that includes an internal wedge surface. A series of circularly arranged swaging dies have external conical wedge surfaces that mate with the internal wedge surface, and they form an internal chamber and support to hold the tube and/or rod. As the annular ring moves axially, the swaging dies close radially around the tube and/or rod. The radial compressive forces cause the tube to deform around the bristle bundle. Arrows S in FIG. 6 represent the force applied by a swaging press.

Hand, bench or hydraulic swaggers may be used to make the brush disclosed herein. In one embodiment, the swaging press is of a type used for wire, rope and cable assemblies, such as the Promec Q6000™ Wire and Rope Swager. This machine provides up to 175 tones of swage press power. The Promec swager comprises 2 half circle type dies. For some applications, the ferrule with the bristles therein is swaged multiple times, to obtain a ferrule that is as round as possible and to apply maximum compression. The process of multiple compressions is typically used in the wire rope industry. The sleeve may also be compressed with a multiple dies swaging machine that compresses the ferrule only once. This swaging process is used in the hose and fitting industry and may hold a circular dimension better than a process that uses multiple compressions. Examples of multiple dies swaging machines are those made by Hydrapower Dynamics Limited.

Generally, swaging alone or gluing alone may be used with smaller diameter bristles and as the bristle diameter increases, a combination of swaging and gluing may be more useful. However, whether swaging, gluing or a combination of both is used, will depend upon a number of factors, including the pull strength required and the length of the brush trim. Without being limited to a theory, it appears that with the smaller bristle diameters, because there is less air space between the bristles, either gluing or swaging may be used. As the diameter of the bristles increases and there is a concomitant increase in the air space between the bristles, both gluing and swaging appear to provide better and more consistent results in terms of bristle retention.

The inventors have found that, generally, gluing and swaging provides greater retention (as measured by pull strength) of the bristles than does either process alone, and that the addition of primer to the glue provides for even better retention. Swaging also provides the added benefit, particularly for brushes that are to be used in MFL tools, of compressing and aligning the bristles, squeezing out excess air between the bristles, and forcing the bristles into close contact with one another. Further, in some embodiments the metal brush may, after the bristles are secured in the ferrule, be ground to various profiles at its bottom end 236.

The bristles 224 at the outer end of tuft may take various forms, such as flat, as shown, angled, irregular, etc. The end of tuft may be formed by selected placement of the bristles 224 during manufacture of the brush or by shaping after the bristles are set in the ferrule.

In accordance with another option, a brush such as brush 216 may be constructed by welding or soldering the bristles 224 into the ferrule 222. In one embodiment, for example, the metal brush 216 comprises at least one bundle of bristles 224, the ends of which are welded to each other and also to ferrule 222 with filler metal.

“Metal”, as used herein, may include alloys. “Welding” is a reference to fusion welding, which is a coalescence of metals that is achieved through the application of sufficient heat with or without pressure to melt the base metal. Fusion welding is distinct from non-fusion welding processes such as soldering. In non-fusion welding, a filler metal that has a melting point well below the melting point of the base metal is used to bond two different metal parts together, and the base metal does not actually melt.

Non-limiting examples of fusion welding processes included herein are arc-welding (shielded-metal arc welding, gas-tungsten arc welding, plasma arc welding, gas-metal arc welding, flux-cored arc welding and submerged arc welding), resistance welding, electroslag welding, electron-beam welding and laser beam welding.

“Filler metal” is a reference to molten metal formed during the welding process. In fusion welding processes, the base metal melts and fuses with other metals that may be added by the welding process. Filler metal may comprise base metal alone, for example metal from the bristles 224 and the ferrule 222, or it may comprise base metal and additional metal added by the welding process.

In one embodiment, metal brush bristles 224 are welded to each other and to the ferrule 222 by fusion welding. As is apparent, only the outermost bristles 224 in bundle will be welded directly to the ferrule 222. Examples of processes that may be used to weld the bristles 224 to one another and to the ferrule 222 are metal inert gas (MIG) welding, tungsten inert gas (TIG welding) or quasi-arc welding. The metal rod used may be a steel rod.

As stated above, the types of welding included herein may or may not use additional metal, in addition to the base metal provided from the bristles 224 and the ferrule 222. Therefore, in one embodiment of brush 216, spaces between the bristles 224 and the ferrule 222 may be filled with filler metal, which results from the welding process. In another embodiment of the brush 216, the spaces may not be filled with filler metal.

The ferrule 222 secured brushes may be made by assembling the bundle of bristles 224 within the ferrule 222 and then securing the bristle bundle to the ferrule 222 by soldering, welding, gluing, swaging, or a combination thereof.

An automatic wire cutter may be used to cut, count and assemble an exact number of bristles per tuft. Spools or coils of wire are fed continuously into the automatic wire cutter, where they are straightened, cut to a predetermined length, and assembled into bundles. In one embodiment where a flat brush is desired, as shown, the bristles in a bristle bundle may within a tolerance limit of +/−0.015 inches. Alternatively, precut bristles may be purchased and assembled into bundles by weighing or counting the bristles.

The bristles 224 are assembled in parallel arrangement into a bundle to form a tuft and one end of the bristle bundle may then be inserted into a ferrule 222. This process may be assisted by using a filling device that has straight or sloped sides, or by using a tube holder fixture that has a detachable/locking mechanism, to hold the ferrule 222 while it is being filled with bristles 224.

If the ends of the bristles 224 are to be glued together, one end of the bundle of bristles 224 may then be dipped into a glue bath before or after placement into the ferrule 222. To permit infiltration of glue, the ends of the bristles 224 may be somewhat spread apart. In one embodiment the glue bath has a depth of 0.750 inches. The end of the bundle may be left in the glue to allow time for the glue to wick up between the bristles 224. If the ferrule 222 is a tube, the bristles 224 may have glue applied after they are already surrounded by the ferrule 222 and the ferrule 222 may then be slid down over the end of the bundle. This would act to squeeze excess glue back into the glue bath. A toggle activated sliding jig may be used to move the ferrule 222 to a position that is a specific distance from the end of the bristles 224, after which time the brush 216 may be left for a period of time sufficient to permit the glue to cure.

If the ferrule 222 has a closed end, then a bristle bundle may have glue applied first, after which they are inserted into the retention cavity of the ferrule 222. Alternately, the glue can be introduced to the retention cavity before the bristles 224 are inserted.

If swaging is used to secure the bristles 224 in the ferrule 222, it may be used alone or in addition to gluing, welding or soldering. For swaging, in one embodiment, the ferrule 222 may be loaded into a swaging press. The press then applies compressive force by hammering radially or otherwise compressing the ferrule 222, to deform it inwards and thereby to securely hold the bristle bundle therein. The ultimate shape of the ferrule 222 may be determined by the shape of the die in the swaging press. For example, the die may be circular, oval, hexagonal, or any of a number of other shapes.

Swaging can be employed before or after gluing, welding and/or soldering, as desired. In one embodiment, for example, the bristle bundle may first be secured into a ferrule 222 by swaging and the end of the brush 216 is then dipped into glue to permit the glue to wick upwards between the bristles 224. This method may be preferred in some applications, as the swaging is used to orient and arrange the bristles 224 to have them properly nested together to avoid larger air gaps. The smaller spaces between the bristles 224 seem to provide more effective retention by the added glue.

Ferrule 222 may be positioned so that it extends beyond the lower end surface of the tuft, leaving a space between the end of the ferrule 222 and the lower surface of the bristle bundle. In one embodiment, there is about a 1mm gap between the two respective ends.

Alternately, ferrule 222 may be positioned so that its end is flush with or recessed from the lower surface of the bundle of bristles.

After the bristles 224 are secured within the ferrule 222 by gluing, swaging, or both, the lower end 236 of the brush 216 may be formed by surface grinding or machining to a desired shape. In one embodiment, the lower end may have a distinct return such as a sharp corner such that the brush 216 can catch on the lower shoulder of the recess in which it is installed.

Regardless of the manufacturing process used to construct a brush, stepped portion 226 should be maintained in a condition to securely set against shoulder (i.e. 18a) of the recess in which it is to be installed.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are know or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

We claim:

1. A pipeline pig brush comprising:
a first plate having a front face, a rear face and side edges;
a second plate having a front face, a rear face and side edges, the second plate positioned in series with the first plate such that the rear face of the first plate faces the front face of the second plate;
at least one first plate recess on the rear face of the first plate;
at least one second plate recess on the front face of the second plate, the at least one second plate recess substantially aligned with the at least one first plate recess on the first plate; and
at least one brush having a ferrule and a tuft of bristles, the at least one brush clamped between the first plate and the second plate and positioned to correspond with the at least one first plate recess and the at least one second plate recess and with the tuft of bristles extending past the side edges of the first plate and the side edges of the second plate.

2. The pipeline pig brush of claim 1 wherein the at least one first plate recess further comprises a shoulder facing away from the side edge of the first plate and the at least one second plate recess further comprises a shoulder facing away from the side edges of second plate and wherein the at least one brush has a stepped portion formed between the ferrule and the tuft of bristles and wherein the stepped portion of the at least one brush engages the shoulder of the first plate recess and the shoulder of the second plate recess.

3. The pipeline pig brush of claim 1 wherein the first plate has a central aperture and the second plate has a central aperture and wherein the central aperture in the first plate substantially aligns with the central aperture in the second plate.

4. The pipeline pig brush of claim 1 wherein the first plate and the second plate are held in position with a plurality of fasteners.

5. The pipeline pig brush of claim 4 wherein each fastener comprises a bolt and a nut, each bolt passing through an aperture in the first plate and a substantially aligned aperture in the second plate.

6. The pipeline pig brush of claim 1 wherein the at least one first plate recess has an elongate shape.

7. The pipeline pig brush of claim 6 wherein the at least one first plate recess extends radially from a center of the first plate.

8. The pipeline pig brush of claim 6 wherein the at least one plate recess extends at an angle offset from a radial direction from a center of the first plate.

9. The pipeline pig brush of claim 1 wherein the at least one first plate recess has a rectangular shape.

10. The pipeline pig brush of claim 1 wherein the at least one first plate recess is a slot passing through the first plate.

11. The pipeline pig brush of claim 1 wherein the at least one first plate recess is an indentation in the first plate.

12. The pipeline pig brush of claim 1 wherein the at least one first plate recess has side shoulders and wherein the at least one brush engages the side shoulders of the at least one first plate recess to secure the at least one brush against lateral movement.

13. The pipeline pig brush of claim 1 wherein the at least one first plate recess has a lower shoulder and wherein the at least one brush engages the lower shoulder.

14. The pipeline pig brush of claim 1 further comprising:
a third plate having a front face, a rear face and side edges, the third plate positioned in series with the first plate and the second plate, such that the rear face of the second plate faces the front face of the third plate;
at least one additional plate recess on the rear face of the second plate;
at least one third plate recess on the front face of the third plate, the at least one third plate recess substantially aligned with the at least one additional plate recess on the second plate; and
at least one additional brush having a ferrule and a tuft of bristles, the at least one additional brush clamped between the second plate and the third plate and positioned to correspond with the at least one additional plate recess on the rear side of the second plate and the at least one third plate recess and with the tuft of bristles extending past the side edges of the second plate and the side edges of the third plate.

15. The pipeline pig brush of claim 14 wherein the at least one second plate recess on the front face of the second plate is offset from the at least one additional plate recess on the back face of the second plate.

16. A pipeline pig comprising:
a mandrel; and
a pig brush retained on the mandrel, the pig brush comprising:
a first plate having a front face, a rear face and side edges;
a second plate having a front face, a rear face and side edges, the second plate positioned in series with the first plate, such that the rear face of the first plate faces the front face of the second plate;
at least one first plate recess on the rear face of the first plate;
at least one second plate recess on the front face of the second plate, the at least one second plate recess substantially aligned with the at least one first plate recess on the first plate; and
at least one brush having a ferrule and a tuft of bristles, the at least one brush clamped between the first plate and the second plate and positioned to correspond with the at least one first plate recess and the at least one second plate recess and with the tuft of bristles extending past the side edges of the first plate and the side edges of the second plate.

17. The pipeline pig of claim 16 wherein the at least one first plate recess has a shoulder facing away from the side edge of the first plate and the at least one second plate recess has a shoulder facing away from the side edges of second plate and wherein the at least one brush has a stepped portion formed between the ferrule and the tuft of bristles and wherein the stepped portion of the at least one brush engages the shoulder of the first plate recess and the shoulder of the second plate recess.

18. The pipeline pig of claim 16 wherein the first plate has a central aperture and the second plate has a central aperture, the central aperture of the first plate substantially aligned with the central aperture of the second plate and wherein the mandrel passes through the central aperture of the first plate and the central aperture of the second plate.

19. The pipeline pig of claim 16 wherein the first plate and the second plate are held in position with a plurality of fasteners.

20. The pipeline pig of claim 19 wherein each fastener comprises a bolt and a nut, each bolt passing through an aperture in the first plate and a substantially aligned aperture in the second plate.

21. The pipeline pig of claim 16 further comprising a driver.

22. A method of assembling a pipeline pig brush, the method comprising:
providing a first plate and a second plate, the first plate have a plurality of recesses in a back face of the first plate and the second plate having a plurality of recesses in a front face of the second plate;
placing brushes, each brush having a ferrule and a tuft of bristles, in the recesses in the back face of the first plate so that the tuft of bristles on each brush extends outwards past the side edges of the first plate;
aligning the plurality of recesses on the front face of the second plate with the plurality of recesses on the front face of the second plate; and
securing the first plate together in series with the second plate to clamp the brushes between the first plate and the second plate wherein the brushes are held in place between the first plate and second plate by the plurality of recesses.

23. The method of claim 22 wherein the plurality of recesses on the back face of the first plate have a shoulder facing away from the side edge of the first plate and the plurality of recesses on the front face of the second plate have a shoulder facing away from the side edges of second plate and wherein the brushes have a stepped portion formed between the ferrule and the tuft of bristles of each brush and wherein the stepped portions of the brushes engage the shoulder of the plurality of recesses.

24. The method of claim 22 wherein the first plate has a central aperture and the second plate has a central aperture and wherein when the first plate and second plate are secured in series, the central aperture in the first plate substantially aligns with the central aperture in the second plate.

25. The method of claim 1 wherein the first plate is secured in series with the second plate using fasteners.

26. The method of claim 25 wherein each fastener comprises a bolt and a nut, each bolt passing through an aperture in first plate and a substantially aligned aperture in the second plate.

27. The method of claim 22 wherein the plurality of recesses on the first plate and the have side shoulders that engage the brushes.

28. The method of claim 1 wherein the plurality of recesses on the first plate have lower shoulders for engaging the brushes.

29. The method of claim 22 further comprising:
providing a third plate, the third plate have a plurality of recesses in a front face of the first plate that can be substantially aligned with recesses provided on the back face of the second plate;
placing additional brushes, each additional brush having a ferrule and a tuft of bristles, in the recesses in the back face of the second plate so that the tuft of bristles on each additional brush extends outwards past the side edges of the second plate;
aligning the plurality of recesses on the front face of the third plate with the plurality of recesses on the back face of the second plate; and
securing the third plate together in series with the first plate and the second plate to clamp the additional brushes between the second plate and the third plate wherein the additional brushes are held in place between the second plate and third plate by the plurality of recesses on the back face of the second plate and the plurality of recesses on the front face of the third plate.

30. The method of claim 29 wherein the plurality of recesses on the front face of the second plate are offset from the plurality of recesses on the back face of the second plate.
